(19) United States
(12) Patent Application Publication
(10) Pub. No.: US 2026/0046557 A1
(43) Pub. Date: Feb. 12, 2026

(54) WIRELESS AUDIO RECEPTION APPARATUS, WIRELESS AUDIO TRANSMISSION APPARATUS, AND WIRELESS AUDIO OUTPUT SYSTEM COMPRISING SAME

(71) Applicant: LG ELECTRONICS INC., Seoul (KR)

(72) Inventors: Byounghak JEONG, Seoul (KR); Yoonjung CHO, Seoul (KR); Suhyun PARK, Seoul (KR)

(73) Assignee: LG ELECTRONICS INC., Seoul (KR)

(21) Appl. No.: 19/099,680

(22) PCT Filed: Aug. 3, 2022
(86) PCT No.: PCT/KR2022/011504

§ 371 Date: Jan. 29, 2025

(51) Int. Cl. H04R 3/00; H04R 1/10; H04W 4/80

(52) U.S. Cl. CPC H04R 3/00; H04R 1/10; H04W 4/80; H04R 2420/07

(57) ABSTRACT

A wireless audio receiving device, a wireless audio transmitting device, and a wireless audio output system including the same are disclosed. The wireless audio receiving device according to an embodiment of the present disclosure comprises a transceiver configured to receive a device information request from a wireless audio transmitting device, through UWB communication, transmit a device information response in response to the device information request, and receive an audio signal from the wireless audio transmitting device wirelessly connected, based on the device information response, and a sound output device configured to output a sound corresponding to the audio signal received from the transceiver, wherein the device information response includes service information for identifying an audio service or a location determination service. Accordingly, it is possible to transmit device information when providing an audio service based on UWB communication.

### BACKGROUND

### 1. Field

This disclosure relates to a wireless audio receiving device, a wireless audio transmitting device, and a wireless audio output system including the same, and more particularly, to a wireless audio receiving device, a wireless audio transmitting device, and a wireless audio output system including the same that can transmit device information when providing audio service based on ultra-wideband (UWB) communication.

Further, this disclosure relates to a wireless audio receiving device, a wireless audio transmitting device, and a wireless audio output system including the same that can stably perform audio service based on UWB communication.

### 2. Description of the Related Art

A wireless audio receiving device wirelessly receives an audio signal from an external wireless audio transmitting device, converts the received audio signal into sound, and outputs it.

Meanwhile, High Definition Video Transmission Using Bluetooth over UWB DOI:10.1109/TCE.2010.5439122 (Mar. 29, 2010) (hereinafter referred to as “prior literature”) published in IEEE discloses setting signaling information for UWB connection via Bluetooth and then transmitting high-speed data via UWB communication.

In particular, the prior literature discloses setting a channel for the UWB communication through Bluetooth connection and transmitting high-speed data through the UWB communication.

However, according to prior literature, when connecting to the UWB communication, there is a drawback in that device information is searched and it is not possible to connect to a device selected from the searched device information.

### SUMMARY

The disclosure has been made in view of the above problems, and may provide a wireless audio receiving device, a wireless audio transmitting device, and a wireless audio output system including the same that can transmit device information when providing audio service based on UWB communication.

The disclosure may further provide a wireless audio receiving device, a wireless audio transmitting device, and a wireless audio output system including the same that can stably perform audio service based on UWB communication.

The disclosure may further provide a wireless audio receiving device, a wireless audio transmitting device, and a wireless audio output system including the same that can stably receive audio wirelessly and output sound even when the wireless environment is complex.

In accordance with an aspect of the present disclosure, a wireless audio receiving device and a wireless audio system including the same include a transceiver configured to receive a device information request from a wireless audio transmitting device, through UWB communication, transmit a device information response in response to the device information request, and receive an audio signal from the wireless audio transmitting device wirelessly connected, based on the device information response, and a sound output device configured to output a sound corresponding to the audio signal received from the transceiver, and the device information response includes service information for identifying an audio service or a location determination service.

Meanwhile, the device information response may further include mode information to indicate information on a type of the audio service capable of being supported.

Meanwhile, the device information response may further include location information indicating a sound channel or location of the wireless audio receiving device.

Meanwhile, the device information response may further include identifier information on coordinate set information of multiple devices.

Meanwhile, the device information request may be received within a beacon message.

Meanwhile, the transceiver may be configured to receive a device association request from the wireless audio transmitting device after transmitting the device information response, and may be wirelessly connected to the wireless audio transmitting device, based on the device association request.

Meanwhile, the transceiver may be configured to transmit the device information response through a communication method corresponding to an additional audio service, when the information on the type of the audio service capable of being supported corresponds to a multi mode including the additional audio service in addition to the UWB communication-based service.

Meanwhile, the transceiver may be configured to transmit the device information response through the UWB communication, when the information on the type of the audio service capable of being supported corresponds to a mono mode not including an additional audio service in addition to the UWB communication-based service.

Meanwhile, the device information request may include mode information for indicating information on the type of the audio service capable of being supported, type information for identifying a message type, and service information for identifying the audio service or the location determination service.

In accordance with an aspect of the present disclosure, a wireless audio transmitting device and a wireless audio system including the same include a transceiver configured to transmit a device information request to a wireless audio receiving device, through UWB communication, receive a device information response from the wireless audio transmitting device, wirelessly connect to the wireless audio transmitting device based on the device information response, through the UWB communication, and transmit an audio signal to the wireless audio transmitting device wirelessly connected, and the device information request includes service information to identify an audio service or a location determination service.

Meanwhile, the device information request may further include type information to identify a message type, and mode information to indicate information on a type of the audio service capable of being supported.

In accordance with another aspect of the present disclosure, a wireless audio receiving device and a wireless audio system including the same include a transceiver configured to wirelessly transmit advertising data to a wireless audio transmitting device based on a first communication standard of a first frequency band, receive a device association request from the wireless audio transmitting device, wirelessly connect to the wireless audio transmitting device, based on the device association request, and wirelessly receive an audio signal based on a second communication standard of a second frequency band greater than the first frequency band, and a sound output device configured to output a sound corresponding to the audio signal received from the transceiver, and the advertising data includes service information for identifying an audio service or a location determination service.

Meanwhile, the transceiver may be configured to transmit an association request to the wireless audio transmitting device after receiving the device association request, receive an association response from the wireless audio transmitting device, and be wirelessly connected to the wireless audio transmitting device based on the second communication standard, on the basis of the association response.

Meanwhile, the advertising data may further include type information to identify a data type.

In accordance with another aspect of the present disclosure, a wireless audio transmitting device and a wireless audio system including the same include a transceiver configured to receive advertising data from a wireless audio receiving device based on a first communication standard of a first frequency band, transmit a device association request to the wireless audio receiving device, wirelessly connect to the wireless audio receiving device, based on the device association request, and wirelessly transmit an audio signal to the wireless audio receiving device based on a second communication standard of a second frequency band greater than the first frequency band, and the advertising data includes service information for identifying an audio service or a location determination service.

Meanwhile, the transceiver may be configured to receive an association request from the wireless audio receiving device after transmitting the device association request, transmit an association response to the wireless audio transmitting device, and be wirelessly connected to the wireless audio receiving device based on the second communication standard, on the basis of the association response.

Meanwhile, the advertising data may further include type information to identify a data type.

### EFFECTS OF THE DISCLOSURE

A wireless audio receiving device and a wireless audio system including the same according to an embodiment of the present disclosure include: a transceiver configured to receive a device information request from a wireless audio transmitting device, through UWB communication, transmit a device information response in response to the device information request, and receive an audio signal from the wireless audio transmitting device wirelessly connected, based on the device information response, and a sound output device configured to output a sound corresponding to the audio signal received from the transceiver, and the device information response includes service information for identifying an audio service or a location determination service. Accordingly, it is possible to transmit device information including service information when providing audio service based on UWB communication. Accordingly, it is possible to stably perform the audio service based on the UWB communication, on the basis of the device information. In addition, it is possible to stably receive audio wirelessly and output sound even when the wireless environment is complex.

Meanwhile, the device information response may further include mode information to indicate information on a type of the audio service capable of being supported. Accordingly, it is possible to transmit device information including mode information when providing audio service based on UWB communication.

Meanwhile, the device information response may further include location information indicating a sound channel or location of the wireless audio receiving device. Accordingly, it is possible to transmit device information including location information when providing audio service based on UWB communication.

Meanwhile, the device information response may further include identifier information on coordinate set information of multiple devices. Accordingly, it is possible to transmit device information including identifier information when providing audio service based on UWB communication.

Meanwhile, the device information request may be received within a beacon message. Accordingly, it is possible to conveniently transmit device information using a beacon message.

Meanwhile, the transceiver may be configured to receive a device association request from the wireless audio transmitting device after transmitting the device information response, and may be wirelessly connected to the wireless audio transmitting device, based on the device association request. Accordingly, it is possible to stably perform an audio service based on UWB communication.

Meanwhile, the transceiver may be configured to transmit the device information response through a communication method corresponding to an additional audio service, when the information on the type of the audio service capable of being supported corresponds to a multi mode including the additional audio service in addition to the UWB communication-based service. Accordingly, it is possible to stably perform an audio service based on UWB communication.

Meanwhile, the transceiver may be configured to transmit the device information response through the UWB communication, when the information on the type of the audio service capable of being supported corresponds to a mono mode not including an additional audio service in addition to the UWB communication-based service. Accordingly, it is possible to stably perform an audio service based on UWB communication.

Meanwhile, the device information request may include mode information for indicating information on the type of the audio service capable of being supported, type information for identifying a message type, and service information for identifying the audio service or the location determination service. Accordingly, it is possible to transmit device information including various pieces of information when providing an audio service based on UWB communication.

A wireless audio transmitting device and a wireless audio system including the same according to an embodiment of the present disclosure include a transceiver configured to transmit a device information request to a wireless audio receiving device, through UWB communication, receive a device information response from the wireless audio transmitting device, wirelessly connect to the wireless audio transmitting device based on the device information response, through the UWB communication, and transmit an audio signal to the wireless audio transmitting device wirelessly connected, and the device information request includes service information to identify an audio service or a location determination service. Accordingly, it is possible to transmit device information including service information when providing audio service based on UWB communication. Accordingly, it is possible to stably perform the audio service based on the UWB communication, on the basis of the device information. In addition, it is possible to stably transmit audio wirelessly even when the wireless environment is complex.

Meanwhile, the device information request may further include type information to identify a message type, and mode information to indicate information on a type of the audio service capable of being supported. Accordingly, it is possible to transmit device information including various pieces of information when providing an audio service based on UWB communication.

A wireless audio receiving device and a wireless audio system including the same according to another embodiment of the present disclosure include a transceiver configured to wirelessly transmit advertising data to a wireless audio transmitting device based on a first communication standard of a first frequency band, receive a device association request from the wireless audio transmitting device, wirelessly connect to the wireless audio transmitting device, based on the device association request, and wirelessly receive an audio signal based on a second communication standard of a second frequency band greater than the first frequency band, and a sound output device configured to output a sound corresponding to the audio signal received from the transceiver, and the advertising data includes service information for identifying an audio service or a location determination service. Accordingly, it is possible to transmit device information including service information when providing audio service based on UWB communication. Accordingly, it is possible to stably perform the audio service based on the UWB communication, on the basis of the device information. In addition, it is possible to stably receive audio wirelessly and output sound even when the wireless environment is complex.

Meanwhile, the transceiver may be configured to transmit an association request to the wireless audio transmitting device after receiving the device association request, receive an association response from the wireless audio transmitting device, and be wirelessly connected to the wireless audio transmitting device based on the second communication standard, on the basis of the association response. Accordingly, it is possible to stably perform an audio service based on UWB communication.

Meanwhile, the advertising data may further include type information to identify a data type. Accordingly, it is possible to transmit device information including type information when providing audio service based on UWB communication.

A wireless audio transmitting device and a wireless audio system including the same according to another embodiment of the present disclosure include a transceiver configured to receive advertising data from a wireless audio receiving device based on a first communication standard of a first frequency band, transmit a device association request to the wireless audio receiving device, wirelessly connect to the wireless audio receiving device, based on the device association request, and wirelessly transmit an audio signal to the wireless audio receiving device based on a second communication standard of a second frequency band greater than the first frequency band, and the advertising data includes service information for identifying an audio service or a location determination service. Accordingly, it is possible to transmit device information including service information when providing audio service based on UWB communication. Accordingly, it is possible to stably perform the audio service based on the UWB communication, on the basis of the device information. In addition, it is possible to stably transmit audio wirelessly even when the wireless environment is complex.

Meanwhile, the transceiver may be configured to receive an association request from the wireless audio receiving device after transmitting the device association request, transmit an association response to the wireless audio transmitting device, and be wirelessly connected to the wireless audio receiving device based on the second communication standard, on the basis of the association response. Accordingly, it is possible to stably perform an audio service based on UWB communication.

Meanwhile, the advertising data may further include type information to identify a data type. Accordingly, it is possible to transmit device information including type information when providing audio service based on UWB communication.

### BRIEF DESCRIPTION OF THE DRAWINGS

FIGS. 1A to 1E are diagrams illustrating a wireless audio system including a wireless audio receiving device and a wireless audio transmitting device according to various embodiments of the present disclosure;

FIG. 2 is an example of an internal block diagram of the wireless audio receiving device of FIGS. 1A to 1E;

FIGS. 3A to 8B are diagrams for explaining an operation of a wireless audio receiving device or a wireless audio transmitting device according to an embodiment of the present disclosure;

FIG. 9 is an example of a flowchart showing a method of operating a wireless audio output system according to an embodiment of the present disclosure;

FIGS. 10 to 12 are diagrams for explaining FIG. 9.

FIG. 13 is an example of a flowchart showing a method of operating a wireless audio output system according to another embodiment of the present disclosure; and

FIGS. 14 to 16 are diagrams for explaining FIG. 13.

### DETAILED DESCRIPTION OF THE PREFERRED EMBODIMENTS

Hereinafter, the present disclosure will be described in more detail with reference to the drawings.

The suffixes such as “module” and “unit” may be used to refer to elements or components. Use of such suffixes herein is merely intended to facilitate description of the specification, and the suffixes do not have any special meaning or function. Accordingly, the “module”and “unit”may be used interchangeably.

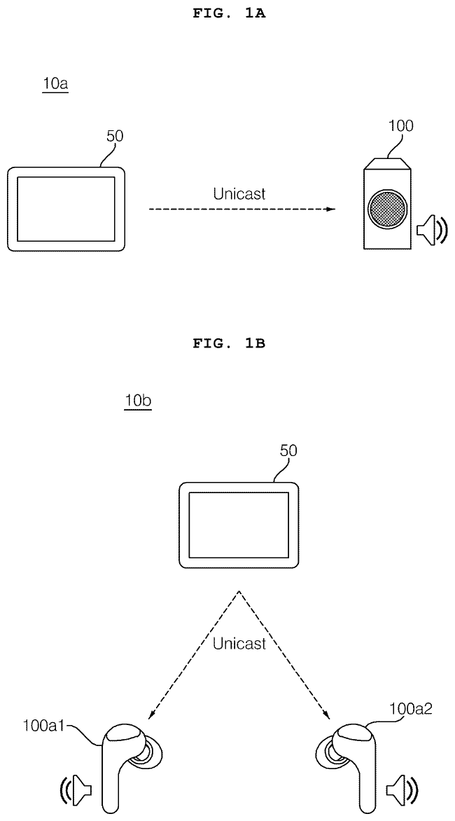

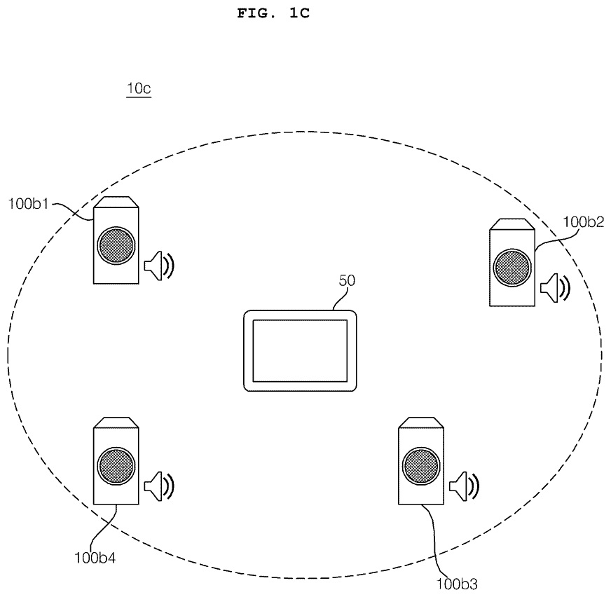

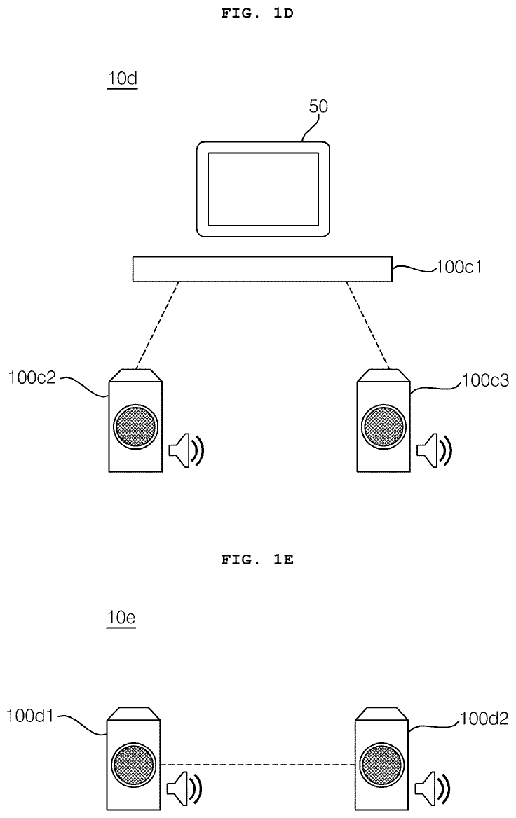

FIGS. 1A to 1E are diagrams illustrating a wireless audio system including a wireless audio receiving device and a wireless audio transmitting device according to various embodiments of the present disclosure.

First, FIG. 1A illustrates a wireless audio system 10a according to an embodiment of the present disclosure.

Referring to FIG. 1A, the wireless audio system 10a according to an embodiment of the present disclosure may include a wireless audio transmitting device 50 and a wireless audio receiving device 100.

In particular, in the wireless audio system 10a, the wireless audio transmitting device 50 and the wireless audio receiving device 100 may correspond one-to-one, based on a unicast method.

The wireless audio transmitting device 50 may include a first communication module 135a wirelessly transmitting a first audio signal based on a first communication standard of a first frequency band, and a second communication module 135b wirelessly transmitting a second audio signal based on a second communication standard of a second frequency band greater than the first frequency band.

Meanwhile, the wireless audio receiving device 100 may include a first communication module 135a wirelessly receiving a first audio signal according to the first communication standard of a first frequency band, and a second communication module 135b wirelessly receiving a second audio signal according to the second communication standard of a second frequency band greater than the first frequency band.

For example, when the wireless audio receiving device 100 outputs the first sound wirelessly based on the first audio signal according to the first communication standard of the first frequency band received from the first communication module 135a and then the packet error rate of the first audio signal is equal to or higher than a predetermined value in complex wireless environments, the device may output the second sound wirelessly based on the second audio signal according to the second communication standard of the second frequency band received from the second communication module 135b.

Accordingly, even in complex wireless environments, it is possible to stably receive audio wirelessly and output sound.

Meanwhile, the wireless audio receiving device 100 receives a device information request from the wireless audio transmitting device 50 through UWB communication, transmits a device information response in response to the device information request, receive an audio signal from the wireless audio transmitting device wirelessly connected based on the UWB communication on the basis of the device information response, and outputs a sound corresponding to the audio signal.

At this time, the device information response includes service information to identify audio service or location determination service. Thus, when providing the audio service based on the UWB communication, it is possible to transmit device information including the service information. Therefore, on the basis of the device information, the audio service based on the UWB communication can be stably performed.

At this time, the wireless audio transmitting device 50 may be a mobile terminal such as a mobile phone or tablet.

Next, FIG. 1B illustrates a wireless audio system 10b according to another embodiment of the present disclosure.

Referring to FIG. 1B, the wireless audio system 10b according to another embodiment of the present disclosure may include a wireless audio transmitting device 50 and a plurality of wireless audio receiving devices 100a1 and 100a2.

In particular, the wireless audio system 10b may include a wireless audio transmitting device 50 and a plurality of wireless audio receiving devices 100a1 and 100a2, based on a unicast method.

For example, when wireless audio signals of a first channel to a second channel are output from the wireless audio transmitting device 50, a wireless audio signal of the first channel may be transmitted to a first wireless audio receiving device 100a1 among a plurality of wireless audio receiving devices 100a1 and 100a2, and a wireless audio signal of the second channel may be transmitted to a second wireless audio receiving device 100a2. Accordingly, it is possible to stably receive audio wirelessly and output sound even in complex wireless environments.

Meanwhile, when each of the wireless audio receiving devices 100a1 to 100a2 outputs the first sound wirelessly based on the first audio signal according to the first communication standard of the first frequency band received from the first communication module 135a and then the packet error rate of the first audio signal is equal to or higher than a predetermined value in complex wireless environments, the device may output the second sound wirelessly based on the second audio signal according to the second communication standard of the second frequency band received from the second communication module 135b. Accordingly, it is possible to stably receive audio wirelessly and output sound even in complex wireless environments.

Meanwhile, each of the wireless audio receiving devices 100a1 to 100a2 receives a device information request from the wireless audio transmitting device 50 through UWB communication, transmits a device information response in response to the device information request, receive an audio signal from the wireless audio transmitting device wirelessly connected based on the UWB communication on the basis of the device information response, and outputs a sound corresponding to the audio signal.

At this time, the device information response includes service information to identify audio service or location determination service. Thus, when providing the audio service based on the UWB communication, it is possible to transmit device information including the service information. Therefore, on the basis of the device information, the audio service based on the UWB communication can be stably performed.

At this time, the plurality of wireless audio receiving devices 100a1 and 100a2 may be left and right wireless audio receiving devices, respectively.

Next, FIG. 1C illustrates a wireless audio system 10c according to another embodiment of the present disclosure.

Referring to FIG. 1C, a wireless audio system 10c according to another embodiment of the present disclosure may include a wireless audio transmitting device 50 and a plurality of wireless audio receiving devices 100b1 to 100b4.

In particular, the wireless audio system 10c may include a wireless audio transmitting device 50 and a plurality of wireless audio receiving devices 100b1 to 100b4, based on a broadcast method.

For example, when wireless audio signals of first to fourth channels are output from the wireless audio transmitting device 50, a wireless audio signal of a first channel may be transmitted to a first wireless audio receiving device 100b1 among a plurality of wireless audio receiving devices 100b1 to 100b4, a wireless audio signal of a second channel may be transmitted to a second wireless audio receiving device 100b2, a wireless audio signal of a third channel may be transmitted to a third wireless audio receiving device 100b3, and a wireless audio signal of a fourth channel may be transmitted to a fourth wireless audio receiving device 100b4. Accordingly, it is possible to stably receive audio wirelessly and output sound even in complex wireless environments.

Meanwhile, when each of the wireless audio receiving devices 100b1 to 100b4 outputs the first sound wirelessly based on the first audio signal according to the first communication standard of the first frequency band received from the first communication module 135a and then the packet error rate of the first audio signal is equal to or higher than a predetermined value in complex wireless environments, the device may output the second sound wirelessly based on the second audio signal according to the second communication standard of the second frequency band received from the second communication module 135b. Accordingly, it is possible to stably receive audio wirelessly and output sound even in complex wireless environments.

Meanwhile, each of the wireless audio receiving devices 100b1 to 100b4 receives a device information request from the wireless audio transmitting device 50 through UWB communication, transmits a device information response in response to the device information request, receive an audio signal from the wireless audio transmitting device wirelessly connected based on the UWB communication on the basis of the device information response, and outputs a sound corresponding to the audio signal.

Next, FIG. 1D illustrates a wireless audio system 10d according to another embodiment of the present disclosure.

Referring to FIG. 1D, the wireless audio system 10d according to another embodiment of the present disclosure may include a wireless audio transmitting device 50 and a plurality of wireless audio receiving devices 100c1 to 100c3.

In particular, the wireless audio system 10d may include a wireless audio transmitting device 50 and a plurality of wireless audio receiving devices 100c1 to 100c3, based on a unicast method.

For example, when wireless audio signals of first to third channels are output from the wireless audio transmitting device 50, a wireless audio signal of a first channel may be transmitted to a first wireless audio receiving device 100c1 among a plurality of wireless audio receiving devices 100c1 to 100c3, a wireless audio signal of a second channel may be transmitted to a second wireless audio receiving device 100c2, and a wireless audio signal of a third channel may be transmitted to a third wireless audio receiving device 100c3.

As another example, when wireless audio signals of first to third channels are output from the wireless audio transmitting device 50, wireless audio signals of a first channel to a third channel may be transmitted to a first wireless audio receiving device 100c1 among a plurality of wireless audio receiving devices 100c1 to 100c3, the first wireless audio receiving device 100c1 may output wireless audio signals of second to third channels, a wireless audio signal of the second channel may be transmitted to a second wireless audio receiving device 100c2, and a wireless audio signal of the third channel may be transmitted to a third wireless audio receiving device 100c3.

Accordingly, even though the wireless environment is complicated, it is possible to stably receive audio wirelessly and output sound.

Meanwhile, when each of the wireless audio receiving devices 100c1 to 100c3 outputs the first sound wirelessly based on the first audio signal according to the first communication standard of the first frequency band received from the first communication module 135a and then the packet error rate of the first audio signal is equal to or higher than a predetermined value in complex wireless environments, the device may output the second sound wirelessly based on the second audio signal according to the second communication standard of the second frequency band received from the second communication module 135b. Accordingly, it is possible to stably receive audio wirelessly and output sound even in complex wireless environments.

Meanwhile, each of the wireless audio receiving devices 100c1 to 100c3 receives a device information request from the wireless audio transmitting device 50 through UWB communication, transmits a device information response in response to the device information request, receive an audio signal from the wireless audio transmitting device wirelessly connected based on the UWB communication on the basis of the device information response, and outputs a sound corresponding to the audio signal.

At this time, the device information response includes service information to identify audio service or location determination service. Thus, when providing the audio service based on the UWB communication, it is possible to transmit device information including the service information. Therefore, on the basis of the device information, the audio service based on the UWB communication can be stably performed.

Next, FIG. 1E illustrates a wireless audio system 10e according to another embodiment of the present disclosure.

Referring to FIG. 1E, a wireless audio system 10e according to another embodiment of the present disclosure may include a plurality of wireless audio receiving devices 100d1 and 100d2.

In particular, the wireless audio system 10e may include a plurality of wireless audio receiving devices 100d1 and 100d2, based on a unicast method.

For example, when a wireless audio signal is output from the first wireless audio receiving device 100d1, the wireless audio signal may be transmitted to the second wireless audio receiving device 100d2.

Accordingly, even though the wireless environment is complicated, it is possible to stably receive audio wirelessly and output sound.

Meanwhile, when each of the wireless audio receiving devices 100d1 to 100d2 outputs the first sound wirelessly based on the first audio signal according to the first communication standard of the first frequency band received from the first communication module 135a and then the packet error rate of the first audio signal is equal to or higher than a predetermined value in complex wireless environments, the device may output the second sound wirelessly based on the second audio signal according to the second communication standard of the second frequency band received from the second communication module 135b. Accordingly, it is possible to stably receive audio wirelessly and output sound even in complex wireless environments.

Meanwhile, each of the wireless audio receiving devices 100d1 and 100d2 receives a device information request from the wireless audio transmitting device 50 through UWB communication, transmits a device information response in response to the device information request, receive an audio signal from the wireless audio transmitting device wirelessly connected based on the UWB communication on the basis of the device information response, and outputs a sound corresponding to the audio signal.

At this time, the device information response includes service information to identify audio service or location determination service. Thus, when providing the audio service based on the UWB communication, it is possible to transmit device information including the service information. Therefore, on the basis of the device information, the audio service based on the UWB communication can be stably performed.

Meanwhile, the wireless audio transmitting device 50 illustrated in FIGS. 1A to 1E may be a mobile terminal, a TV, a monitor, a tablet, a home appliance, a vehicle display device, and the like.

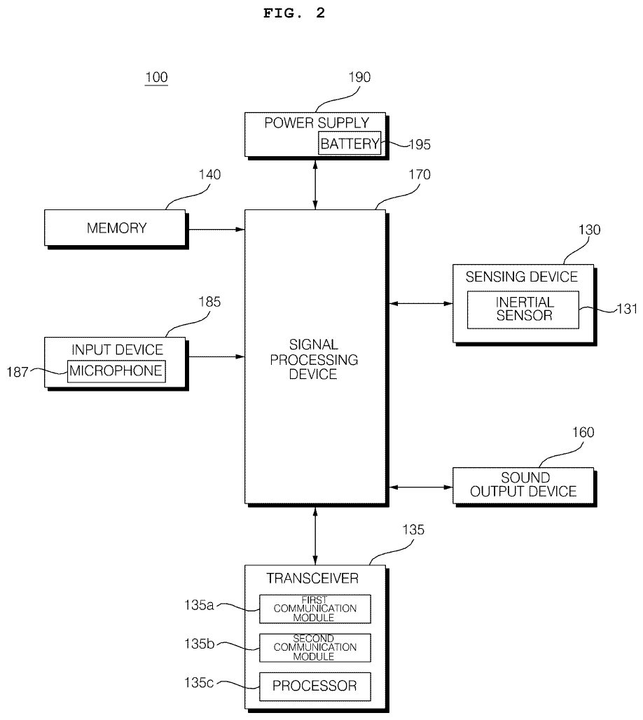

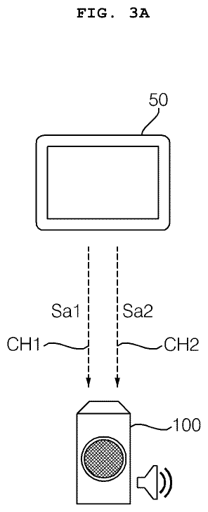

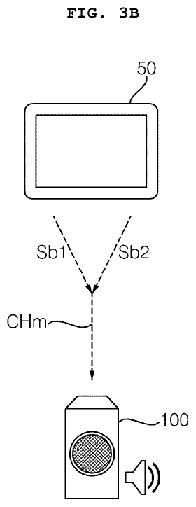

FIG. 2 is an example of an internal block diagram of the wireless audio receiving device of FIGS. 1A to 1E.

Referring to FIG. 2, the wireless audio receiving device 100 may include a sensing device 130, a transceiver 135, a memory 140, a sound output device 160, a signal processing device 170, an input device 185, and a power supply 190. When these components are implemented in actual applications, if necessary, two or more components may be combined into one component, or one component may be subdivided into two or more components.

The sensing device 130 may include an inertial sensor 131. The inertial sensor may include an acceleration sensor, a gyro sensor, a gravity sensor, or the like. For example, the acceleration sensor, the gyro sensor, the gravity sensor, or the like may include a 6-axis sensor.

The sensing device 130 may output motion information of the wireless audio receiving device 100, for example, movement information (acceleration information, angular velocity information) or location information based on x, y, z axis.

Meanwhile, the sensing device 130 may include a sensor for obtaining user body information. For example, a blood pressure sensor, a brain wave sensor, or the like may be provided.

Meanwhile, the transceiver 135 may provide an interface for communication with an external device. To this end, the transceiver 135 may include at least one of a mobile communication module (not shown), a wireless Internet module (not shown), a short-distance communication module (not shown), or a GPS module (not shown).

For example, the transceiver 135 may perform IR communication, Bluetooth communication, or WiFi communication, thereby exchanging data with a paired wireless audio transmitting device 50 or transmitting data. In particular, it may be configured to receive an audio signal from the paired wireless audio transmitting device 50.

Meanwhile, the transceiver 135 may include a first communication module 135a that wirelessly receives a first audio signal according to the first communication standard of a first frequency band, and a second communication module 135b that wirelessly receives a second audio signal according to the second communication standard of a second frequency band greater than the first frequency band.

Meanwhile, the transceiver 135 may further include a signal processing device 135c for signal processing or control of the first communication module 135a and the second communication module 135b.

Meanwhile, the first communication module 135a receives a first signal data through a first channel CH1, and separately receives a first audio data through a second channel CH2, and the second communication module 135b separately receives a second signal data and a second audio data through the same channel CHm.

Accordingly, even though the wireless environment is complicated, it is possible to stably receive audio wirelessly and output sound. In addition, signal data and audio data can be distinguished in the first communication module 135a and the second communication module 135b, so that audio can be stably received wirelessly and sound can be output.

Meanwhile, the beacon message received by the second communication module 135b may include unicast information or broadcast information. Accordingly, it is possible to operate by dividing into unicast and broadcast.

Meanwhile, in response to unicast information being included in the received beacon message, the second communication module 135b may be configured to transmit association request information to the wireless audio transmitting device 50 or 100, and may be configured to receive association response information from the wireless audio transmitting device 50 or 100. Accordingly, it is possible to operate by dividing into unicast and broadcast.

Meanwhile, the second communication module 135b may distinguish whether it is the second signal data or the second audio data, based on identification information in the header among the received second audio signal. Accordingly, signal data and audio data can be distinguished, thereby stably receiving audio wirelessly and outputting sound.

Meanwhile, the second communication module 135b may distinguish whether it is the second signal data or the second audio data, based on identification information in a media access control (MAC) header or a physical (PHY) header among the received second audio signal. Accordingly, signal data and audio data can be distinguished, thereby stably receiving audio wirelessly and outputting sound.

Meanwhile, in response to receiving the second signal data, the second communication module 135b may extract encoding or decoding information of the second standard, and based on the extracted encoding or decoding information, may be configured to receive the second audio data after the second signal data, and may set a replay time of the second audio data. Accordingly, signal data and audio data can be distinguished, thereby stably receiving audio wirelessly and outputting sound.

The memory 140 may store programs for processing or controlling the signal processing device 170 in the wireless audio receiving device 100, or may perform a function for temporarily storing input or output data.

The sound output device 160 may output an audio signal processed by the signal processing device 170 in the wireless audio receiving device 100.

Alternatively, the sound output device 160 may output guide information related to the operation of the wireless audio receiving device 100 as an audio signal.

Meanwhile, the sound output device 160 may output a first sound corresponding to the first audio signal from the first communication module 135a or a second sound corresponding to the second audio signal from the second communication module 135b.

The signal processing device 170 may control the overall operation of the wireless audio receiving device 100 by controlling the operation of each unit in the wireless audio receiving device 100.

Meanwhile, the signal processing device 170 may perform signal processing for an audio signal received from the outside.

Meanwhile, the signal processing device 170 may replay an audio signal from the first communication module 135a or the second communication module 135b.

Meanwhile, the signal processing device 170 may replay the second audio data, based on the decoding information from the second communication module 135b and a set replay time. Accordingly, signal data and audio data can be distinguished, thereby stably receiving audio wirelessly and outputting sound.

Meanwhile, the input device 185 may include a button for initializing the wireless audio receiving device 100, or inputting an operation.

Meanwhile, the input device 185 may include a microphone 187 for sound collection.

Meanwhile, the input device 185 may include a camera (not shown) for capturing images.

For example, as shown in FIG. 2, the input device 185 may include, in the drawing, a power key 185a for turning power on or off, a FF/REW key 185b for going forward or backward in the reproducing audio, a volume key 185c for volume up or down, a pause/play key 185d for playing or pausing audio, and the like.

The power supply 190 may supply power required for operation of each component under the control of the signal processing device 170.

In particular, the power supply 190 may include a battery 195 that stores and outputs DC power.

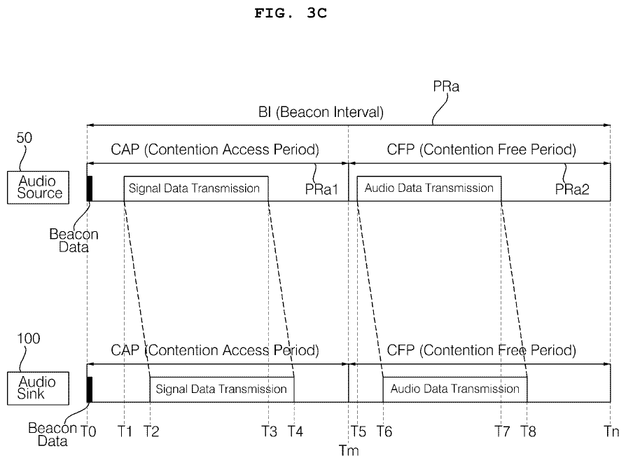

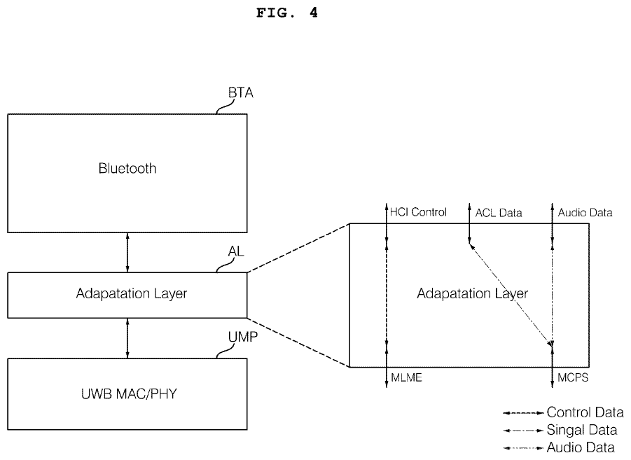

FIGS. 3A to 8B are diagrams for explaining an operation of a wireless audio receiving device or a wireless audio transmitting device according to an embodiment of the present disclosure.

FIG. 3A illustrates that the wireless audio transmitting device 50 outputs a first signal data Sa1 and a first audio data Sa2 to the wireless audio receiving device 100.

Referring to FIG. 3A, the wireless audio transmitting device 50 wirelessly outputs the first signal data Sa1 and the first audio data Sa2 according to the first communication standard of a first frequency band.

In particular, the wireless audio transmitting device 50 may be configured to transmit the first signal data Sa1 through the first channel CH1, and separately transmit the first audio data Sa2 through the second channel CH2.

Accordingly, the first communication module 135a in the wireless audio receiving device 100 according to an embodiment of the present disclosure receives the first signal data Sa1 through the first channel CH1, and distinguishes and receives the first audio data Sa2 through the second channel CH2.

FIG. 3B illustrates that the wireless audio transmitting device 50 outputs the second signal data Sb1 and the second audio data Sb2 to the wireless audio receiving device 100.

Referring to FIG. 3B, the wireless audio transmitting device 50 wirelessly outputs the second signal data Sb1 and the second audio data Sb2 according to the second communication standard of a second frequency band greater than the first frequency band.

In particular, the wireless audio transmitting device 50 may separately transmit the second signal data Sb1 and the second audio data Sb2 through the same channel CHm.

Accordingly, the second communication module 135b in the wireless audio receiving device 100 according to an embodiment of the present disclosure separately receives the second signal data Sb1 and the second audio data Sb2 through the same channel CHm.

Meanwhile, the first communication standard may be a Bluetooth communication standard, and the second communication standard may be an ultra-wideband (UWB) communication standard.

For example, the wireless audio transmitting device 50 may wirelessly transmit an audio signal according to the first communication standard, and then wirelessly transmit the audio signal according to the second communication standard when the wireless environment is complicated.

Accordingly, the wireless audio receiving device 100 may stably receive audio wirelessly and output sound even though the wireless environment is complicated. In addition, signal data and audio data can be distinguished in the first communication module 135a and the second communication module 135b, so that audio can be stably received wirelessly and sound can be output.

Meanwhile, the first communication module 135a according to an embodiment of the present disclosure may be configured to transmit the first signal data Sa1 through the first channel CH1, and may be configured to transmit the first audio data Sa2 separately through the second channel CH2. The second communication module 135b may be configured to transmit the second signal data Sb1 and the second audio data Sb2 separately through the same channel CHm. Accordingly, it is possible to stably transmit audio wirelessly even in complex wireless environments. In addition, the signal data and the audio data can be separately transmitted.

Meanwhile, the beacon message transmitted from the second communication module 135b in the wireless audio transmitting device 50 may include unicast information or broadcast information. Accordingly, it is possible to operate by dividing into unicast and broadcast.

Meanwhile, when the second communication module 135b in the wireless audio transmitting device 50 includes unicast information in the transmitted beacon message, it may be configured to receive association request information from the wireless audio receiving device 100, and may be configured to transmit the association request information from an electronic device to the wireless audio receiving device 100. Accordingly, it is possible to operate by dividing into unicast and broadcast. Further, it is possible to check whether UWB wireless audio support is available, allowing audio data to be wirelessly transmitted.

Meanwhile, the second communication module 135b in the wireless audio transmitting device 50 may add identification information in a media access control (MAC) header or a physical (PHY) header in order to distinguish whether the transmitted second audio signal is the second signal data Sb1 or the second audio data Sb2. Accordingly, it is possible to operate by dividing into unicast and broadcast.

Meanwhile, when the first communication module 135a in the wireless audio transmitting device 50 transmits the first audio signal and then the second communication module 135b transmits the second audio signal, Host Control Interface (HCI) data of the first communication standard may be mapped to MAC Layer Management Entity (MLME) interface of the second communication standard, and Asynchronous Connection-Less (ACL) data and audio data of the first communication standard may be mapped to a MAC Common Part Sublayer (MCPS) interface of the second communication standard. Accordingly, signal data and audio data can be distinguished, thereby stably transmitting audio wirelessly.

Meanwhile, when the first communication module 135a in the wireless audio transmitting device 50 transmits the first audio signal and then the second communication module 135b transmits the second audio signal, an adaptation layer (AL) may be used to map data of the first communication standard to data of the second communication standard. Accordingly, signal data and audio data can be distinguished, thereby stably transmitting audio wirelessly.

Meanwhile, when the second communication module 135b in the wireless audio transmitting device 50 transmits the second audio signal, it may be configured to transmit the second signal data Sb1 in a contention access period (CAP) of the beacon interval PRa, and may be configured to transmit the second audio data Sb2 in a contention free period (CFP) of the beacon interval PRa. Accordingly, signal data and audio data can be distinguished, thereby stably transmitting audio wirelessly.

Meanwhile, the first communication module 135a in the wireless audio transmitting device 50 may be configured to transmit the first signal data Sa1 and transmit identification information in the first signal data Sa1 to the second communication module 135b, and the second communication module 135b may separately transmit the second signal data Sb1 in the second audio signal, based on the identification information from the first communication module 135a. Accordingly, signal data and audio data can be distinguished, thereby stably transmitting audio wirelessly.

Meanwhile, the first communication module 135a in the wireless audio transmitting device 50 may be configured to transmit the first audio data Sa2 and transmit identification information in the first audio data Sa2 to the second communication module 135b, and the second communication module 135b may separately transmit the second audio data Sb2 in the second audio signal, based on the identification information from the first communication module 135a. Accordingly, signal data and audio data can be distinguished, thereby stably transmitting audio wirelessly.

Meanwhile, the second communication module 135b in the wireless audio transmitting device 50 may be configured to receive a security activation value from the wireless audio receiving device 100, and if it matches, generate a key, and encrypt and transmit the second audio data Sb2 by using the generated key. Accordingly, it is possible to stably transmit audio wirelessly based on security.

FIG. 3C is a diagram for explaining the operation of the wireless audio transmitting device 50 and the first communication module 135a of the wireless audio receiving device 100.

Referring to FIG. 3, the wireless audio transmitting device 50 may wirelessly transmit beacon data at time To during the beacon interval PRa, and the wireless audio receiving device 100 may wirelessly receive the beacon data.

Meanwhile, the wireless audio transmitting device 50 may be configured to transmit signal data in a contention access period (CAP) of the beacon interval PRa, and transmit audio data in a contention free period (CFP) of the beacon interval PRa.

In particular, FIG. 3 illustrates that signal data is transmitted between time T1 and time T3 within a contention access period (CAP), and audio data is transmitted between time T5 and time T7 within a contention free period (CFP).

In response, the wireless audio receiving device 100 may be configured to receive signal data between time T2 and time T4 within a contention access period (CAP), and may be configured to receive audio data between time T6 and time T8 within a contention free period (CFP).

That is, when the second communication module 135b in the wireless audio receiving device 100 receives the second audio signal, it may be configured to receive the second signal data Sb1 in the contention access period (CAP) of the beacon interval PRa, and may be configured to receive the second audio data Sb2 in the contention free period (CFP) of the beacon interval PRa. Accordingly, signal data and audio data can be distinguished, thereby stably receiving audio wirelessly and outputting sound.

FIG. 4 is a diagram for explaining mapping between the first communication standard and the second communication standard.

Referring to FIG. 4, in order to provide a UWB audio service which is an example of the second communication standard, Bluetooth audio, which is an example of the first communication standard optimized for the audio service, is adopted as an upper protocol.

Bluetooth audio (BTA) interface is composed of HCI Control, ACL Data, and Audio Data.

Meanwhile, the Media access control or physical layer (MAC/PHY) (UMP) of UWB may have a MAC Layer Management Entity (MLME) interface and a MAC Common Part Sublayer (MCPS) interface.

Meanwhile, for mapping between Bluetooth audio (BTA) and UWB media access control or a physical layer (MAC/PHY) (UMP), an adaptation layer (AL) is utilized in an embodiment of the present disclosure.

In the adaptation layer (AL), Host Control Interface (HCI) data of the first communication standard may be mapped to MAC Layer Management Entity (MLME) interface of the second communication standard, and Asynchronous Connection-Less (ACL) data and audio data of the first communication standard may be mapped to a MAC Common Part Sublayer (MCPS) interface of the second communication standard.

Meanwhile, UWB wireless transmission or UWB wireless reception has a frequency band 3.1 GHz to 10.6 GHz different from the unlicensed band 2.4 GHz, thereby avoiding frequency interference with other wireless devices using the unlicensed band, and solving problems such as audio interruption.

In addition, since UWB wireless transmission or UWB wireless reception provides a higher PHY data rate than Bluetooth wireless transmission or wireless reception, high-quality audio service is possible.

Meanwhile, when the first communication module 135a receives the first audio signal and then the second communication module 135b receives the second audio signal, Host Control Interface (HCI) data of the first communication standard may be mapped to the MAC Layer Management Entity (MLME) interface of the second communication standard, and Asynchronous Connection-Less (ACL) data and audio data of the first communication standard may be mapped to the MAC Common Part Sublayer (MCPS) interface of the second communication standard. Accordingly, signal data and audio data can be distinguished, thereby stably receiving audio wirelessly and outputting sound.

Meanwhile, when the first communication module 135a receives the first audio signal and then the second communication module 135b receives the second audio signal, data of the first communication standard may be mapped to data of the second communication standard by using an adaptation layer AL. Accordingly, signal data and audio data can be distinguished, thereby stably receiving audio wirelessly and outputting sound.

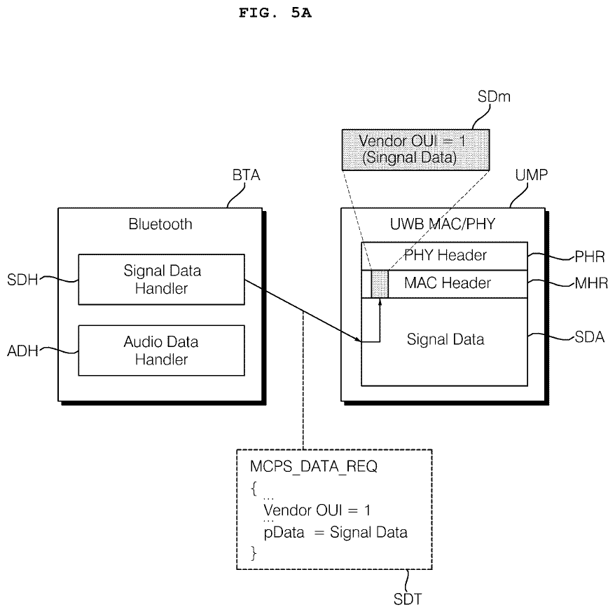

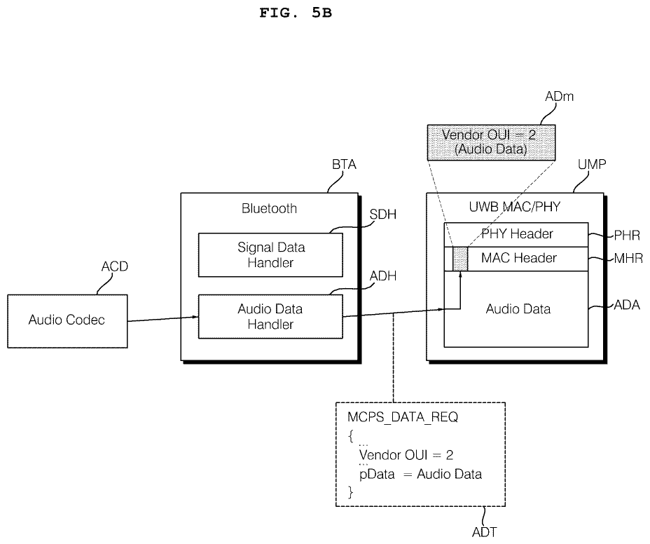

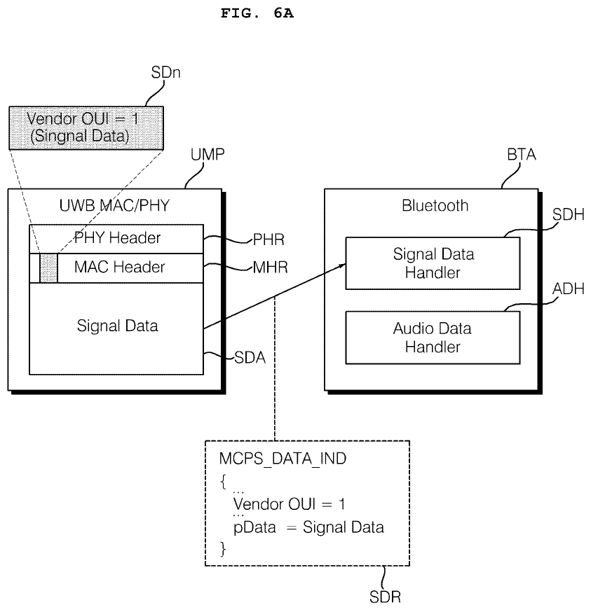

FIGS. 5A and 5B are diagrams for explaining an operation of a wireless audio transmitting device.

Referring to the drawing, the signal data handler SDH in the Bluetooth audio BTA of the wireless audio transmitting device 50 may define an identifier for distinguishing between signal data and audio data by using the Vendor OUI Field of the UWB MAC Header.

FIG. 5A illustrates signal data SDT when the Vendor OUI is ‘1’, and FIG. 5B illustrates audio data ADT when the Vendor OUI is ‘2’.

In particular, the Bluetooth audio BTA of the wireless audio transmitting device 50 may be configured to transmit signal data SDT for codec and QoS configuration used in the UWB audio service.

Meanwhile, when the wireless audio transmitting device 50 transmits the signal data SDT to the Media access control or physical layer (MAC/PHY) (UMP) of UWB, Vendor OUI, which is UWB MAC Header, may be set to ‘1’ and transmitted.

Meanwhile, in the wireless audio receiving device 100, when codec and QoS configuration are completed, audio data may be transmitted from the audio codec to Bluetooth audio BTA, and Bluetooth Audio BTA may be transmitted to the Media access control or physical layer (MAC/PHY) (UMP) of UWB by setting the Vendor OUI, which is UWB MAC Header, to ‘2’.

In addition, the wireless audio transmitting device 50 may be configured to transmit audio data to the wireless audio receiving device 100 with respect to Media access control or physical layer (MAC/PHY) (UMP) of UWB. Accordingly, even though the wireless environment is complicated, it is possible to stably receive audio wirelessly and output sound.

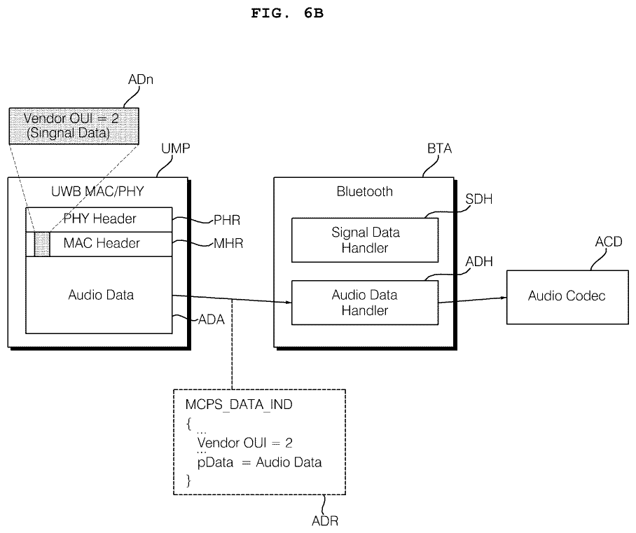

FIGS. 6A and 6B are diagrams for explaining an operation of a wireless audio receiving device.

Referring to the drawing, an identifier for distinguishing between signal data and audio data of Bluetooth audio (BTA) may be defined through the MCPS interface of the wireless audio receiving device 100.

FIG. 6A illustrates signal data SDR when the Vendor OUI is ‘1’, and FIG. 6B illustrates audio data ADR when the Vendor OUI is ‘2’.

When the Media access control or physical layer (MAC/PHY) (UMP) of UWB of the wireless audio receiving device 100 receives data having Vendor OUI, which is the UWB MAC Header, that is set to ‘1’, Bluetooth audio BTA may move to the signal data handler SDH.

In particular, the Bluetooth audio BTA of the wireless audio receiving device 100 may be configured to receive codec and QoS information used in the UWB audio service through a signal data handler SDH, and set information necessary for audio data reception.

Meanwhile, when the codec and QoS configuration for UWB audio service are completed, data whose Vendor OUI, which is the UWB MAC Header, is ‘2’ is received, and Bluetooth audio BTA may move to the audio data handler ADH.

The Bluetooth audio BTA sets a reproducing time for audio data received through an audio data handler (ADH), and the audio data having set reproducing time is transmitted to an audio codec. Accordingly, even though the wireless environment is complicated, it is possible to stably receive audio wirelessly and output sound.

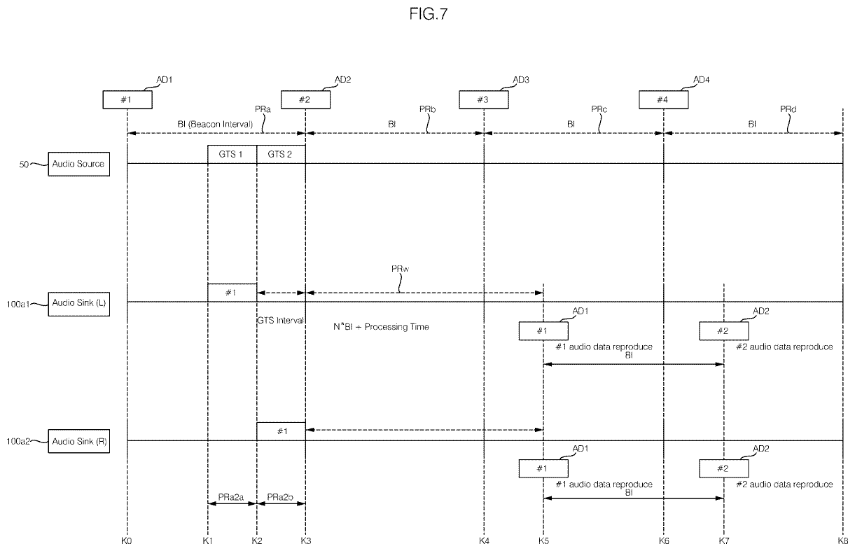

FIG. 7 is a diagram for explaining an UWB audio reproducing time synchronization.

Referring to FIG. 7, the wireless audio transmitting device 50 may sequentially transmit first to fourth audio data AD1 to AD4 to a plurality of wireless audio receiving devices 100a1 and 100a2 respectively.

In particular, the wireless audio transmitting device 50 may sequentially transmit the first to fourth audio data AD1 to AD4 for each channel in a beacon interval.

FIG. 7 illustrates that a first audio data AD1 is generated at time K0, transmitted to a first wireless audio receiving device 100a1 in an interval PRa2a between time K1 and time K2, and transmitted to a second wireless audio receiving device 100a2 in an interval PRa2b between time K2 and time K3.

Meanwhile, the interval PRa2a and the interval PRa2b may be set respectively by a plurality of wireless audio receiving devices 100a1 and 100a2 that receive audio data.

Similarly, at time K3, a second audio data AD2 is generated, and transmitted to the first wireless audio receiving device 100a1 and the second wireless audio receiving device 100a2, within a second beacon interval PRb.

Similarly, at time K4, a third audio data AD3 is generated, and transmitted to the first wireless audio receiving device 100a1 and the second wireless audio receiving device 100a2, within a third beacon interval PRc.

Similarly, at time K6, a fourth audio data AD4 is generated, and transmitted to the first wireless audio receiving device 100a1 and the second wireless audio receiving device 100a2, within a fourth beacon interval PRd.

Meanwhile, in order to synchronize and reproduce the first audio data AD1 received in a first beacon interval PRa in the plurality of wireless audio receiving devices 100a1 and 100a2, it is preferable that it is not reproduced in a second beacon interval PRb, but reproduced at the time K5 in the third beacon interval PRc.

That is, after audio data is received, it is preferable that it is reproduced not in the next beacon interval but in the beacon interval after next.

Meanwhile, it is preferable that the interval PRw from the audio data reception completion time K3 to the reproducing start point K5 is greater than the length of the beacon interval. Accordingly, it is possible to stably synchronize and reproduce audio data.

Meanwhile, after the first audio data AD1 is reproduced at the time K5, it is preferable that the second audio data AD2 is spaced apart by the beacon interval and reproduced at the time K7. Accordingly, it is possible to stably synchronize and reproduce audio data.

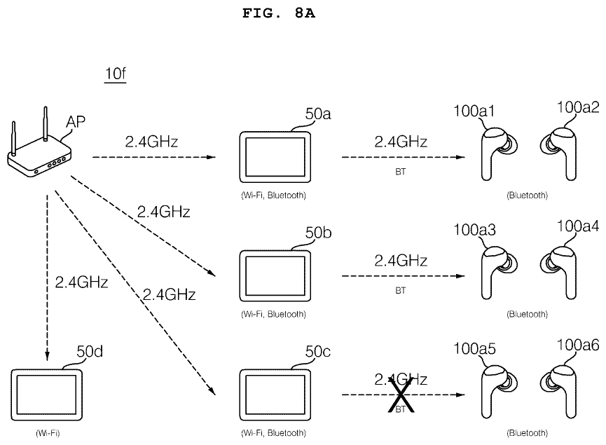

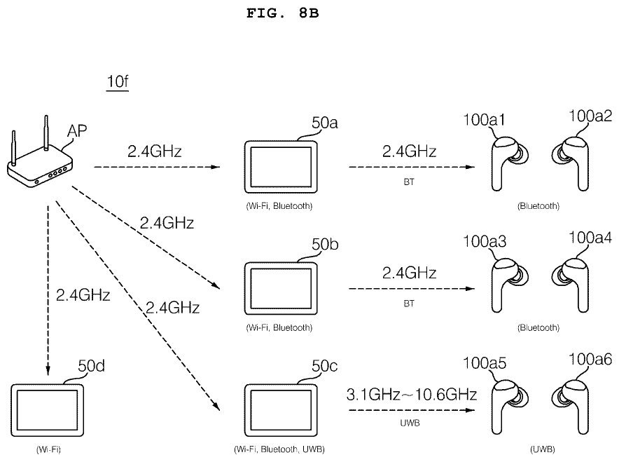

FIGS. 8A and 8B illustrate a wireless audio system 10f including an AP device (AP), a plurality of wireless audio transmitting devices 50a to 50d, and a plurality of wireless audio receiving devices 100a1 to 100a6.

As shown in FIG. 8A, in a complicated wireless environment, between the plurality of wireless audio transmitting devices 50a to 50d and the plurality of wireless audio receiving devices 100a1 to 100a6, when audio is transmitted wirelessly by using Bluetooth communication which is the same first communication standard, audio data transmission becomes impossible due to frequency interference.

FIG. 8A illustrates that audio data transmission is impossible due to frequency interference, between a third wireless audio transmitting device 50c and the plurality of wireless audio receiving devices 100a5 to 100a6.

In order to solve this problem, an embodiment of the present disclosure utilizes the second communication standard having a larger frequency band and a larger bandwidth than the first communication standard. The second communication standard may be UWB.

As shown in FIG. 8B, in a complicated wireless environment, it is preferable that among a plurality of wireless audio transmitting devices 50a to 50d and a plurality of wireless audio receiving devices 100a1 to 100a6, devices excluding the third wireless audio transmitting device 50c and the plurality of wireless audio receiving devices 100a5 to 100a6 use Bluetooth communication which is the first communication standard, and the third wireless audio transmitting device 50c and the plurality of wireless audio receiving devices 100a5 to 100a6 use UWB communication. Accordingly, it is possible to stably transmit and receive wireless audio data even in a complicated wireless environment.

Meanwhile, the UWB communication may be suitable for the complex wireless environment, because it has low frequency congestion and is resistant to interference.

Thus, while the UWB communication is used to detect indoor positioning, it is used for the audio service in the present disclosure.

Meanwhile, the UWB communication is provided as a standard specification such as IEEE 802.15.4. However, as no method for selecting the device for the UWB communication is provided, the present disclosure proposes a method for transmitting device information to enable device selection when providing the audio service based on the UWB communication. This will be described with reference to FIG. 9 and below.

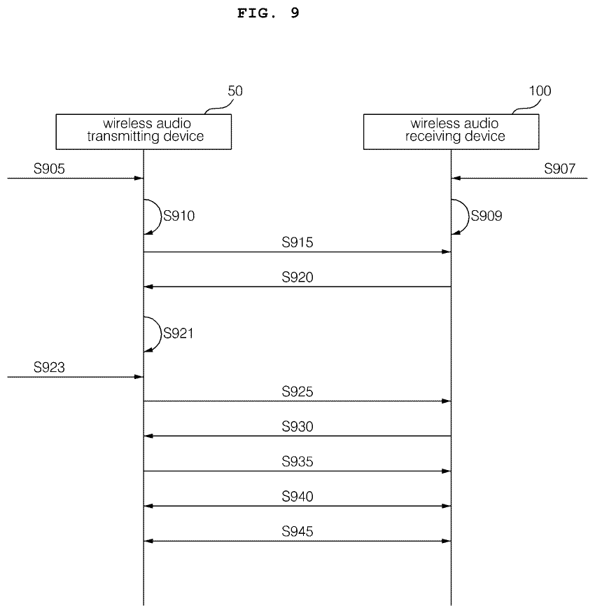

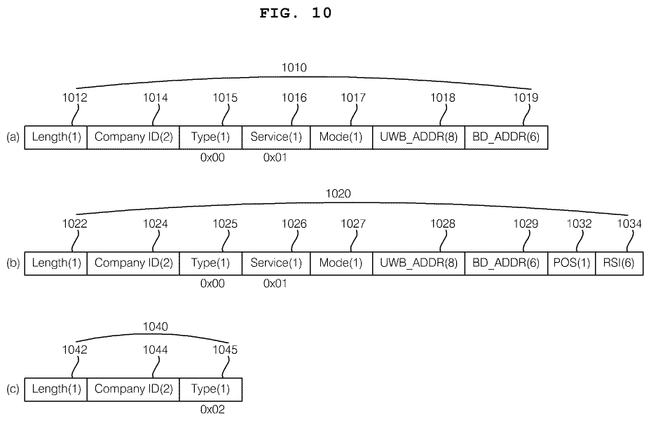

FIG. 9 is an example of a flowchart showing a method of operating a wireless audio output system according to an embodiment of the present disclosure, and FIGS. 10 to 12 are diagrams for explaining FIG. 9.

Referring to the drawings, the wireless audio transmitting device 50, which is an audio source, receive a request for searching the UWB communication device based on an input signal, in step S905.

For example, when the wireless audio transmitting device 50 is a mobile terminal, it may be configured to receive the request for searching the UWB communication device based on a touch input or voice input of the display 180.

In response to the request for searching the UWB communication device, the wireless audio transmitting device 50 may set a UWB Personal Area Network (PAN) in step S910.

Meanwhile, the wireless audio receiving device 100, which is an audio sink, receive a wake up signal in step S907.

At this time, the wake up signal may include a power-on signal based on a power button or the like, a cover open signal of a cradle (not shown), or a separation signal from the cradle.

The wireless audio receiving device 100 may perform beacon scanning, based on the wake up signal in step S909.

Next, the wireless audio transmitting device 50 may be configured to transmit a device information request after setting the UWB PAN in step S915.

Meanwhile, a device information request 1010 may be transmitted while being included in the beacon message, and the wireless audio receiving device 100 may be configured to receive the device information request included in the beacon message.

At this time, the device information request 1010 may include length information 1012, ID information 1014, type information 1015, service information 1016, mode information 1017, UWB extended address information 1018, and Bluetooth address information 1019, as shown in FIG. 10(a).

The length information 1012 may indicate the length of the device information request 1010, and the ID information 1014 may include a value to prevent compatibility conflicts with other UWB services.

The type information 1015 may indicate information for identifying a message type. For example, when a message is the device information request, it may have the value of 0x00.

The service information 1016 may include information for identifying the audio service or the location determination service.

For example, the service information 1016 may have a first value such as 0x01 when providing the audio service, and may have a second value such as 0x02 when providing the location determination service.

The mode information 1017 may indicate information on the type of the audio service capable of being supported.

For example, the mode information 1017 may have the value of 0x01 when the supported audio service is Bluetooth, the value of 0x02 when the supported audio service is BLE, and the value of 0x04 when the supported audio service is UWB.

Meanwhile, the mode information 1017 may have the value of 0x05 when there are multiple supported audio services, Bluetooth and UWB, the value of 0x06 when the supported audio services are BLE and UWB, and the value of 0x07 when the supported audio services are Bluetooth, BLE, and UWB.

Meanwhile, the UWB extended address information 1018 may indicate an extended address based on the UWB communication, and the Bluetooth address information 1019 may indicate an address based on the Bluetooth communication.

Meanwhile, the wireless audio receiving device 100 receives the device information request 1010 from the wireless audio transmitting device 50 via the UWB communication, and transmits a device information response 1020 in response to the device information request 1010, in step S920.

At this time, the device information response 1020 may be transmitted while being included in the beacon message.

As shown in FIG. 10(b), the device information response 1020 may include length information 1022, ID information 1024, type information 1025, service information 1026, mode information 1027, UWB extended address information 1028, Bluetooth address information 1029, location information 1032, and identifier information 1034.

The length information 1022 may indicate the length of the device information response 1020, and the ID information 1024 may include a value to prevent compatibility conflicts with other UWB services.

The type information 1025 may indicate information for identifying a message type. For example, when a message is the device information response, it may have the value of 0x01.

The service information 1026 may include information for identifying the audio service or the location determination service.

For example, the service information 1026 may have a first value such as 0x01 when providing the audio service, and may have a second value such as 0x02 when providing the location determination service.

The mode information 1027 may indicate information on the type of the audio service capable of being supported.

For example, the mode information 1027 may have the value of 0x01 when the supported audio service is Bluetooth, the value of 0x02 when the supported audio service is BLE, and the value of 0x04 when the supported audio service is UWB.

Meanwhile, the mode information 1027 may have the value of 0x05 when there are multiple supported audio services, Bluetooth and UWB, the value of 0x06 when the supported audio services are BLE and UWB, and the value of 0x07 when the supported audio services are Bluetooth, BLE, and UWB.

Meanwhile, the UWB extended address information 1028 may indicate an extended address based on the UWB communication, and the Bluetooth address information 1029 may indicate an address based on the Bluetooth communication.

Meanwhile, the location information 1032 may indicate the sound channel or location of the wireless audio receiving device 100.

For example, when the sound channel or location of the wireless audio receiving device 100 is left, the location information 1032 may have the value of 0x01. When the sound channel or location of the wireless audio receiving device 100 is right, the location information 1032 may have the value of 0x02.

As another example, when the sound channel or location of the wireless audio receiving device 100 is center, the location information 1032 may have the value of 0x03.

Meanwhile, the identifier information 1034 may include an identifier for coordinate set information of multiple devices.

Meanwhile, the wireless audio transmitting device 50 receives the device information response 1020 from the wireless audio receiving device 100 through the UWB communication, analyzes information in the device information response 1020, and displays UWB audio supporting device information on a display (not shown) based on the analyzed information in step S921.

For example, when the mode information 1027 in the received device information response 1020 has the value of 0x04, the value of 0x05, the value of 0x06, o the value of 0x07, the wireless audio transmitting device 50 is a device capable of providing the audio service based on UWB communication, and may display the wireless audio transmitting device 50 on the display (not shown).

Meanwhile, the device capable of providing the audio service based on UWB communication may be selected based on input from a user or automatically, in step S923.

For example, the wireless audio transmitting device 50 may be selected as the device capable of providing the audio service based on UWB communication.

As such, when connecting to the UWB communication, device information is searched and the searched device information is provided, thereby enabling the audio service based on the UWB communication to be stably provided.

Next, the wireless audio transmitting device 50 transmits a device association request 1040 to the wireless audio receiving device 100, based on the selection of the wireless audio transmitting device 50 in step S925.

At this time, the device association request 1040 may be transmitted while being included in the beacon message.

As shown in FIG. 10(c), the device association request 1040 may include length information 1042, ID information 1044, and type information 1045.

The length information 1042 may indicate the length of the device association request 1040, and the ID information 1024 may include a value to prevent compatibility conflicts with other UWB services.

The type information 1045 may indicate information for identifying a message type. For example, when a message is the device association request 1040, it may have the value of 0x02.

Meanwhile, the wireless audio receiving device 100 receives the device association request 1040 from the wireless audio transmitting device 50 via the UWB communication, and transmits an association request through the UWB communication to the wireless audio transmitting device 50 in response to the device association request 1040, in step S930.

Thus, the wireless audio transmitting device 50 receives the association request, and transmits the association response through the UWB communication to the wireless audio receiving device 100 in response to the association request, in step S935.

The wireless audio transmitting device 50 and the wireless audio receiving device 100 perform service search on the basis of the association request and the association response in step S940, and complete wireless connection based on the UWB communication in step S945.

Accordingly, on the basis of the device information, the audio service based on the UWB communication can be stably performed.

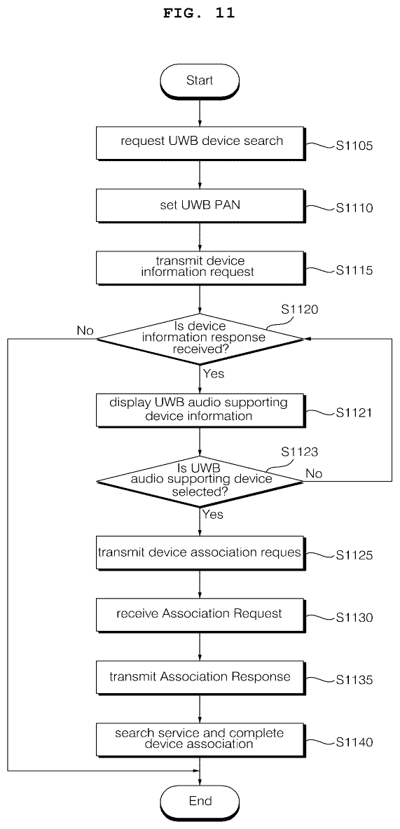

FIG. 11 is an example of a flowchart showing a method of operating a wireless audio transmitting device according to an embodiment of the present disclosure.

Referring to FIG. 11, the wireless audio transmitting device 50, which is an audio source, receive a UWB communication device search request based on an input signal, as in step S905 of FIG. 9, in step S1105.

Next, in response to the UWB communication device search request, the wireless audio transmitting device 50 may set a UWB PAN, as in step S910 of FIG. 9, in step S1110.

Next, the wireless audio transmitting device 50 may be configured to transmit the device information request after setting the UWB PAN, as in step S915 of FIG. 9, in step S1115.

At this time, as shown in FIG. 10(a), the device information request 1010 may include length information 1012, ID information 1014, type information 1015, service information 1016, mode information 1017, UWB extended address information 1018, and Bluetooth address information 1019.

Meanwhile, the wireless audio transmitting device 50 receives the device information response 1020 from the wireless audio receiving device 100 through the UWB communication, as in step S920 of FIG. 9, analyzes information in the device information response 1020, as in step S921 of FIG. 9, and displays the UWB audio supporting device information on the display (not shown), on the basis of the analyzed information, in step S1121.

Meanwhile, when the device capable of providing the audio service based on the UWB communication is selected based on input from a user or automatically, as in step S923 of FIG. 9, the wireless audio transmitting device 50 transmits the device association request 1040 to the wireless audio receiving device 100, as in step S925 of FIG. 9, in step S1125.

Next, the wireless audio transmitting device 50 receives the association request from the wireless audio receiving device 100, as in step S930 of FIG. 9, in step S1130, and transmits the association response through the UWB communication to the wireless audio receiving device 100 in response to the association request, as in step S935 of FIG. 9, in step S1135.

Further, the wireless audio transmitting device 50 performs service search on the basis of the association request and the association response, and completes wireless connection based on the UWB communication in step S1140.

Accordingly, on the basis of the device information, the audio service based on the UWB communication can be stably performed.

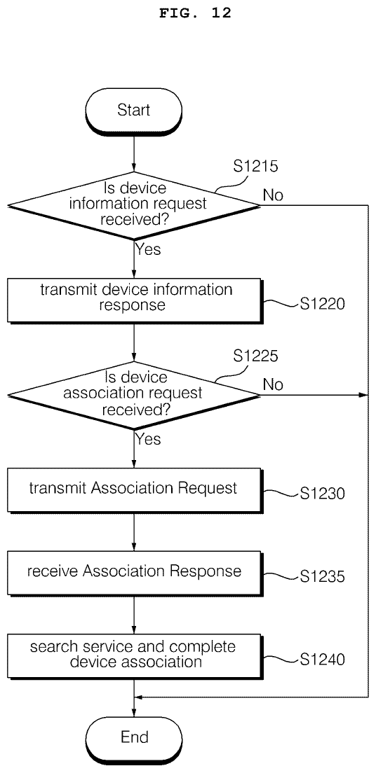

FIG. 12 is an example of a flowchart showing a method of operating a wireless audio receiving device according to an embodiment of the present disclosure.

Referring to FIG. 12, the wireless audio receiving device 100 may perform beacon scanning, based on a wake up signal.

Meanwhile, the wireless audio receiving device 100 receives the device information request 1010 from the wireless audio transmitting device 50 through the UWB communication, as in step S915 of FIG. 9, in step S1215, and transmits the device information response 1020 in response to the device information request 1010, as in step S920 of FIG. 9, in step S1220.

Next, when the wireless audio receiving device 100 receives the device association request 1040 from the wireless audio transmitting device 50 through the UWB communication, as in step S925 of FIG. 9, in step S1225, it transmits the association request through the UWB communication to the wireless audio transmitting device 50, in response to the device association request 1040, as in step S930 of FIG. 9, in step S1230.

Further, the wireless audio receiving device 100 receives the association response from the wireless audio transmitting device 50 through the UWB communication, as in step S935 of FIG. 9, in step S1235.

Further, the wireless audio receiving device 100 performs service search on the basis of the association request and the association response, and completes wireless connection based on the UWB communication in step S1240.

Accordingly, on the basis of the device information, the audio service based on the UWB communication can be stably performed.

Meanwhile, the transceiver 135 in the wireless audio receiving device 100 may be configured to receive the device association request 1040 from the wireless audio transmitting device 50 after transmitting the device information response 1020, and may be wirelessly connected to the wireless audio transmitting device 50 on the basis of the device association request 1040. Thus, the audio service based on the UWB communication can be stably performed.

Meanwhile, when information on the type of the audio service capable of being supported is a multi mode including an additional audio service in addition to the UWB communication-based service, the transceiver 135 in the wireless audio receiving device 100 may be configured to transmit the device information response 1020 through a communication method corresponding to the additional audio service. Thus, the audio service based on the UWB communication can be stably performed.

For example, when the mode information 1026 has the value of 0x05, Bluetooth communication and UWB communication are possible to provide the audio service, so the wireless audio receiving device 100 may operate in the multi mode.

That is, the wireless audio receiving device 100 may perform audio service based on the UWB communication, in complex wireless environment, while performing the audio service based on Bluetooth communication.

Meanwhile, when information on the type of the audio service capable of being supported corresponds to a mono mode not including an additional audio service in addition to the UWB communication-based service, the transceiver 135 in the wireless audio receiving device 100 may be configured to transmit the device information response 1020 through the UWB communication. Thus, the audio service based on the UWB communication can be stably performed.

For example, when the mode information 1026 has the value of 0x04, only the UWB communication is possible to provide the audio service, so the wireless audio receiving device 100 may operate in the mono mode based on the UWB communication.

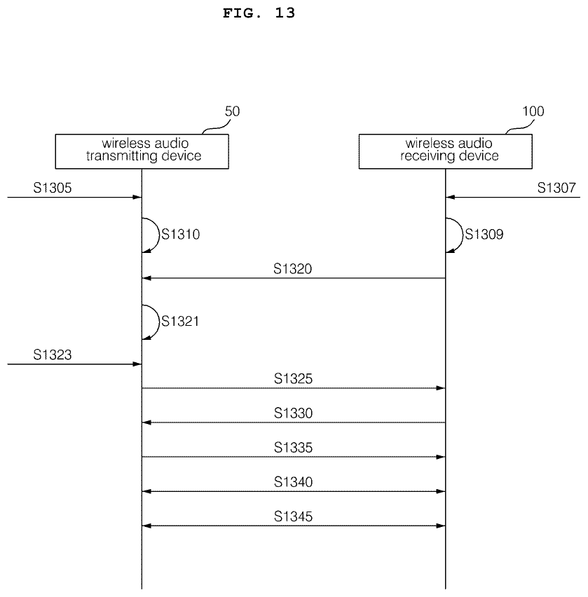

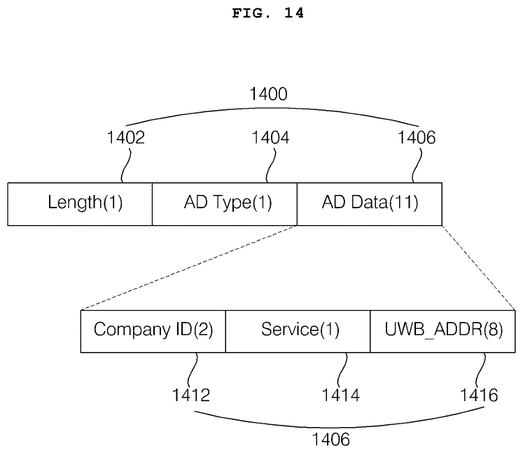

FIG. 13 is an example of a flowchart showing a method of operating a wireless audio output system according to another embodiment of the present disclosure, and FIGS. 14 to 16 are diagrams for explaining FIG. 13.

Referring to the drawings, the wireless audio transmitting device 50, which is an audio source, receive a request for searching the Bluetooth communication device based on an input signal, in step S1305.

For example, when the wireless audio transmitting device 50 is a mobile terminal, it may be configured to receive the request for searching the Bluetooth communication device based on a touch input or voice input of the display 180.

In response to the request for searching the Bluetooth communication device, the wireless audio transmitting device 50 may perform BLE advertising scanning in step S1310.

Meanwhile, the wireless audio receiving device 100, which is an audio sink, receive a wake up signal in step S1307.

At this time, the wake up signal may include a power-on signal based on a power button or the like, a cover open signal of a cradle (not shown), or a separation signal from the cradle.

The wireless audio receiving device 100 may perform Bluetooth advertising and UWB beacon scanning, after setting the UWB audio service in BLE Advertising Data, based on the wake up signal, in step S1309.

The wireless audio receiving device 100 may be configured to transmit advertising data 1400 based on the Bluetooth communication, on the basis of the wake up signal, in step S1320.

As shown in FIG. 14, the advertising data 1400 based on the Bluetooth communication may include length information 1402, type information 1404, and data information 1406.

The length information 1402 may indicate the length of the advertising data 1400, and the type information 1404 may indicate the type information of the advertising data 1400.

For example, the type information 1404 may have the value of 0xFF.

The data information 1406 may include ID information 1412, service information 1414, and UWB extended address information 1416.

The ID information 1412 may include manufacturer ID information.

The service information 1412 may include information for identifying audio service or location determination service.

For example, the service information 1412 may have a first value such as 0x01 when providing the audio service, and may have a second value such as 0x02 when providing the location determination service.

Meanwhile, the UWB extended address information 1416 may indicate an extended address based on the UWB communication.

Meanwhile, the wireless audio transmitting device 50 receives the advertising data 1400 based on the Bluetooth communication in step S1320, analyses the advertising data 1400, and displays the UWB audio supporting device information on a display (not shown) based on the analyzed information in step S1321.

For example, when the service information 1412 in the received advertising data 1400 has the first value such as 0x01, the wireless audio transmitting device 50 is a device capable of providing the audio service based on UWB communication, and may display the wireless audio transmitting device 50 on the display (not shown).

Meanwhile, the advertising data 1400 may further include mode information, similar to the data format of FIG. 11.

For example, when the mode information in the advertising data 1400 has the value of 0x04, the value of 0x05, the value of 0x06, or the value of 0x07, the wireless audio transmitting device 50 is a device capable of providing the audio service based on UWB communication, and may display the wireless audio transmitting device 50 on the display (not shown).

Meanwhile, the device capable of providing the audio service based on UWB communication may be selected based on input from a user or automatically, in step S1323.

For example, the wireless audio transmitting device 50 may be selected as the device capable of providing the audio service based on UWB communication.

As such, when connecting to the UWB communication, device information is searched and the searched device information is provided, thereby enabling the audio service based on the UWB communication to be stably provided.

Next, the wireless audio transmitting device 50 transmits a device association request 1040 to the wireless audio receiving device 100, based on the selection of the wireless audio transmitting device 50 in step S1325.

At this time, the device association request 1040 may be transmitted while being included in the beacon message.

As shown in FIG. 14(c), the device association request 1040 may include length information 1042, ID information 1044, and type information 1045.

Meanwhile, the wireless audio receiving device 100 receives the device association request 1040 from the wireless audio transmitting device 50 via the UWB communication, and transmits an association request through the UWB communication to the wireless audio transmitting device 50 in response to the device association request 1040, in step S1330.

Thus, the wireless audio transmitting device 50 receives the association request, and transmits the association response through the UWB communication to the wireless audio receiving device 100 in response to the association request, in step S1335.

The wireless audio transmitting device 50 and the wireless audio receiving device 100 perform service search on the basis of the association request and the association response in step S1340, and complete wireless connection based on the UWB communication in step S1345.

Accordingly, on the basis of the device information, the audio service based on the UWB communication can be stably performed.

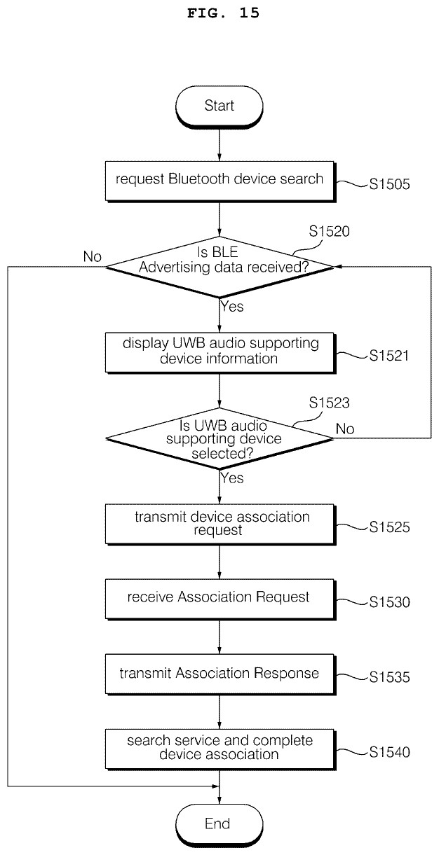

FIG. 15 is an example of a flowchart showing a method of operating a wireless audio transmitting device according to another embodiment of the present disclosure.

Referring to FIG. 15, the wireless audio transmitting device 50, which is an audio source, receive a request for searching the Bluetooth communication device based on an input signal, as in step S1305 of FIG. 13, in step S1505.

Next, in response to the request for searching the Bluetooth communication device, the wireless audio transmitting device 50 may perform BLE Advertising Scanning, as in step S1310 of FIG. 13, in step S1510.

Next, the wireless audio transmitting device 50 receives the advertising data 1400 based on the Bluetooth communication as in step S1320 of FIG. 13, analyses the advertising data 1400, and displays the UWB audio supporting device information on a display (not shown) based on the analyzed information in step S1521.

Meanwhile, when the device capable of providing the audio service based on the UWB communication is selected based on input from a user or automatically, as in step S1323 of FIG. 13, the wireless audio transmitting device 50 transmits the device association request 1040 to the wireless audio receiving device 100, as in step S1325 of FIG. 13, in step S1525.

Next, the wireless audio transmitting device 50 receives the association request from the wireless audio receiving device 100, as in step S1330 of FIG. 13, in step S1530, and transmits the association response through the UWB communication to the wireless audio receiving device 100 in response to the association request, as in step S1335 of FIG. 13, in step S1535.

Further, the wireless audio transmitting device 50 performs service search on the basis of the association request and the association response, and completes wireless connection based on the UWB communication in step S1540.

Accordingly, on the basis of the device information, the audio service based on the UWB communication can be stably performed.

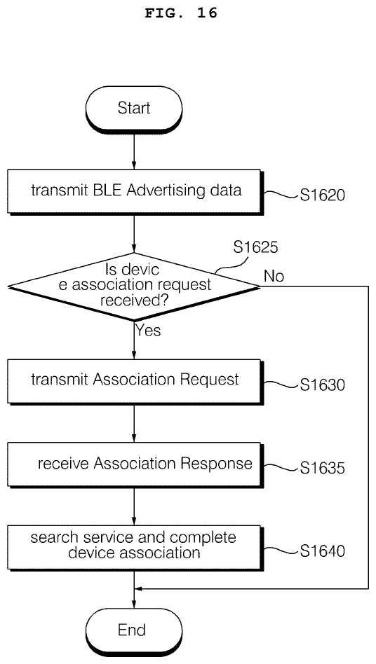

FIG. 16 is an example of a flowchart showing a method of operating a wireless audio receiving device according to another embodiment of the present disclosure.

Referring to FIG. 16, the wireless audio receiving device 100 may perform Bluetooth advertising and UWB beacon scanning, after setting the UWB audio service in BLE Advertising Data, based on the wake up signal.

Meanwhile, the wireless audio receiving device 100 may be configured to transmit advertising data 1400 based on the Bluetooth communication, as in step S1320 of FIG. 13, in step S1620.

Next, when the wireless audio receiving device 100 receives the device association request 1040 from the wireless audio transmitting device 50 through the UWB communication, as in step S1325 of FIG. 13, in S1625, it transmits the association request through the UWB communication to the wireless audio transmitting device 50 in response to the device association request 1040, as in step S1330 of FIG. 13, in step S1630.

Further, the wireless audio receiving device 100 receives the association response from the wireless audio transmitting device 50 through the UWB communication, as in step S1335 of FIG. 13, in step S1635.

Further, the wireless audio receiving device 100 performs service search based on the association request and the association response, and completes wireless connection based on the UWB communication, in step S1640.

Accordingly, on the basis of the device information, the audio service based on the UWB communication can be stably performed.

Although the present disclosure has been described with reference to specific embodiments shown in the drawings, it is apparent to those skilled in the art that the present description is not limited to those exemplary embodiments and is embodied in many forms without departing from the scope of the present disclosure, which is described in the following claims. These modifications should not be individually understood from the technical spirit or scope of the present disclosure.

1. A wireless audio receiving device comprising:
a transceiver configured to receive a device information request from a wireless audio transmitting device, through UWB communication, transmit a device information response in response to the device information request, and receive an audio signal from the wireless audio transmitting device wirelessly connected, based on the device information response; and
a sound output device configured to output a sound corresponding to the audio signal received from the transceiver,
wherein the device information response comprises service information for identifying an audio service or a location determination service,
wherein the service information has a first value in response to providing the audio service, and has a second value in response to providing the location determination service.

2. The wireless audio receiving device of claim 1, wherein the device information response further comprises mode information to indicate information on a type of the audio service capable of being supported.

3. The wireless audio receiving device of claim 1, wherein the device information response further comprises location information indicating a sound channel or location of the wireless audio receiving device.

4. The wireless audio receiving device of claim 1, wherein the device information response further comprises identifier information on coordinate set information of multiple devices.

5. The wireless audio receiving device of claim 1, wherein the device information request is received within a beacon message.

6. The wireless audio receiving device of claim 1, wherein the transceiver is configured to receive a device association request from the wireless audio transmitting device after transmitting the device information response, and wirelessly connect to the wireless audio transmitting device, based on the device association request.

7. The wireless audio receiving device of claim 1, wherein the transceiver is configured to transmit the device information response through a communication method corresponding to an additional audio service, when the information on the type of the audio service capable of being supported corresponds to a multi mode including the additional audio service in addition to the UWB communication-based service.

8. The wireless audio receiving device of claim 1, wherein the transceiver is configured to transmit the device information response through the UWB communication, when the information on the type of the audio service capable of being supported corresponds to a mono mode not including an additional audio service in addition to the UWB communication-based service.

9. The wireless audio receiving device of claim 1, wherein the device information request comprises mode information for indicating information on the type of the audio service capable of being supported, type information for identifying a message type, and service information for identifying the audio service or the location determination service.

10. A wireless audio transmitting device comprising:
a transceiver configured to transmit a device information request to a wireless audio receiving device, through UWB communication, receive a device information response from the wireless audio receiving device, wirelessly connect to the wireless audio receiving device based on the device information response, through the UWB communication, and transmit an audio signal to the wireless audio receiving device wirelessly connected,
wherein the device information request comprises service information to identify an audio service or a location determination service,
wherein the service information has a first value in response to providing the audio service, and has a second value in response to providing the location determination service.

11. The wireless audio transmitting device of claim 10, wherein the device information request further comprises type information to identify a message type, and mode information to indicate information on a type of the audio service capable of being supported.

12. A wireless audio receiving device comprising:
a transceiver configured to wirelessly transmit advertising data to a wireless audio transmitting device based on a first communication standard of a first frequency band, receive a device association request from the wireless audio transmitting device, wirelessly connect to the wireless audio transmitting device, based on the device association request, and wirelessly receive an audio signal based on a second communication standard of a second frequency band greater than the first frequency band; and
a sound output device configured to output a sound corresponding to the audio signal received from the transceiver,
wherein the advertising data comprises service information for identifying an audio service or a location determination service,
wherein the service information has a first value in response to providing the audio service, and has a second value in response to providing the location determination service.

13. The wireless audio receiving device of claim 12, wherein the transceiver is configured to transmit an association request to the wireless audio transmitting device after receiving the device association request, receive an association response from the wireless audio transmitting device, and wirelessly connect to the wireless audio transmitting device based on the second communication standard, on the basis of the association response.

14. The wireless audio receiving device of claim 12, wherein the advertising data further comprises type information to identify a data type.

15. A wireless audio transmitting device comprising:
a transceiver configured to receive advertising data from a wireless audio receiving device based on a first communication standard of a first frequency band, transmit a device association request to the wireless audio receiving device, wirelessly connect to the wireless audio receiving device, based on the device association request, and wirelessly transmit an audio signal to the wireless audio receiving device based on a second communication standard of a second frequency band greater than the first frequency band,
wherein the advertising data comprises service information for identifying an audio service or a location determination service_
wherein the service information has a first value in response to providing the audio service, and has a second value in response to providing the location determination service.

16. The wireless audio transmitting device of claim 15, wherein the transceiver is configured to receive an association request from the wireless audio receiving device after transmitting the device association request, transmit an association response to the wireless audio transmitting device, and wirelessly connect to the wireless audio receiving device based on the second communication standard, on the basis of the association response.

17. The wireless audio transmitting device of claim 15, wherein the advertising data further comprises type information to identify a data type.

18. A wireless audio output system comprising:
a wireless audio transmitting device; and
a wireless audio receiving device,
wherein the wireless audio receiving device comprises:
a transceiver configured to receive a device information request from a wireless audio transmitting device, through UWB communication, transmit a device information response in response to the device information request, and receive an audio signal from the wireless audio transmitting device wirelessly connected, based on the device information response; and
a sound output device configured to output a sound corresponding to the audio signal received from the transceiver,
wherein the device information response comprises service information for identifying an audio service or a location determination service,
wherein the service information has a first value in response to providing the audio service, and has a second value in response to providing the location determination service.

19. The wireless audio output system of claim 18, wherein the wireless audio transmitting device comprises:
a second transceiver configured to transmit a device information request to a wireless audio receiving device, through UWB communication, receive a device information response from the wireless audio receiving device, wirelessly connect to the wireless audio receiving device based on the device information response, through the UWB communication, and transmit an audio signal to the wireless audio receiving device wirelessly connected,
wherein the device information request comprises the service information to identify the audio service or the location determination service.
wherein the service information has the first value in response to providing the audio service, and has the second value in response to providing the location determination service.

20. The wireless audio output system of claim 18, wherein the wireless audio transmitting device comprises:
a second transceiver configured to receive advertising data from a wireless audio receiving device based on a first communication standard of a first frequency band, transmit a device association request to the wireless audio receiving device, wirelessly connect to the wireless audio receiving device, based on the device association request, and wirelessly transmit an audio signal to the wireless audio receiving device based on a second communication standard of a second frequency band greater than the first frequency band,
wherein the advertising data comprises the service information for identifying the audio service or the location determination service,
wherein the service information has the first value in response to providing the audio service, and has the second value in response to providing the location determination service.
